(19) United States
(12) Patent Application Publication
(10) Pub. No.: US 2010/0140511 A1
(43) Pub. Date: Jun. 10, 2010

(54) FLAT DISCHARGE LAMP

(75) Inventors: Guillaume Auday, Bussiere Saint Georges (FR); Laurent Joulaud, Soisy Sous Montmorency (FR); Jingwei Zhang, Massy (FR); Philippe Guillot, Terssac (FR); Philippe Belenguer, Pompertuzat (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Glass France, Courbevoie (FR)

(21) Appl. No.: 12/596,069

(22) PCT Filed: Apr. 17, 2008
(86) PCT No.: PCT/FR2008/050691

§ 371 Date: Feb. 22, 2010

(30) Foreign Application Priority Data
Apr. 17, 2007 (FR) 0754530

(51) Int. Cl. H01J 65/00; H01J 61/42; F21S 8/04; A47F 11/10; F21V 33/00; G09F 13/08; F27D 21/02; B64D 47/02; B60Q 1/00; A47B 97/00; G21K 5/00

(52) U.S. Cl. 250/504 R; 313/607; 313/485; 313/489; 362/147; 362/125; 362/135; 362/97.1; 362/101; 362/154; 362/92; 362/470; 362/477; 362/127

(57) ABSTRACT

The present invention relates to a flat discharge lamp (1000) that transmits in the visible and/or UV comprising first and second dielectric walls (2, 3) that are facing each other, kept parallel and sealed at the periphery (8), that thus define an internal space (10) filled with a plasma gas and comprising a source of UV and/or visible light (6); and first and second electrodes (4, 5) in separate planes parallel to the first and second walls, the first electrode (4) being at a potential V0 higher than the potential V1 of the second electrode, and the first electrode being arranged in the internal space and closer to the first dielectric wall than the second electrode. And the first electrode is spaced apart from the first dielectric wall by the gas, the first and second electrodes are separated by a flat electrical insulator (7) with at least one main face (71, 72), known as a perforated face, equipped with through-holes (73), at least one of the first and second electrodes is in contact with the main perforated face and has discontinuities at least in the extension of said holes.

The invention relates to the field of flat lamps and more particularly concerns a flat discharge lamp that transmits in the UV and/or the visible.

Various types of flat discharge lamps are known.

In the field of UV lamps, known from document US 2004/0227469 is a UV lamp comprising a metal sheet that forms a cathode and bears a discontinuous alumina-type dielectric having a thickness of less than 1 mm, which is covered by a discontinuous anode made of molybdenum or another refractory having a thickness of between 0.1 and 1 mm.

The discontinuities have diameters of a few fractions of 1 mm to 1 cm so that the UV radiation is emitted by the plasma trapped between the electrodes. This UV lamp is inserted in a discharge chamber filled with xenon and is used for the decontamination of liquids.

This UV lamp has the advantage of being powered by a DC or AC voltage and provides a satisfactory power density. However, this UV lamp is fragile, has a limited service life and is of limited use.

Furthermore, in the field of lamps for lighting, flat lamps are known that are composed of two glass sheets that are kept a short distance apart, generally less than a few millimetres, and are hermetically sealed so as to contain a gas under reduced pressure in which an electrical discharge produces radiation, generally in the ultraviolet range, that excites a photoluminescent material which then emits visible light.

Document WO 2006/090086 discloses a flat discharge lamp which comprises:
first and second walls in the form of glass sheets that are kept parallel to one another and that define an internal gas-filled space, and of which the faces turned towards the internal space are each coated with a phosphor material;
first and second electrodes in the form of uniform transparent layers covering the inner faces of the first and second walls under the phosphors; and
a conductor for electrical safety that is in the form of a uniform transparent layer covering the outer face of the first wall.

In order to power this flat lamp, the first electrode is at a potential V0 around 500 to 700 V and the second electrode and the conductor are earthed.

In this lamp, the phosphors are constantly bombarded by the plasma, which weakens it. Moreover, the electrodes are necessarily transparent for lighting through the two faces.

Thus, the object of the present invention is to provide a flat discharge lamp that transmits in the ultraviolet (UV) and/or the visible, which is high performance, with an increased service life and a low cost electrical safeguarding, while remaining robust and simple to use.

For this purpose, the present invention provides a flat discharge lamp that transmits in the visible and/or UV comprising:
first and second dielectric, especially glass, walls that are facing each other, kept parallel (by one or more spacers, by a peripheral frame, etc.) and sealed at the periphery, especially by at least one seal, that thus define an internal space filled with a plasma gas and comprising a source of UV and/or visible light; and
first and second electrodes in separate planes parallel to the first and second walls,
the first electrode being at a potential V0 higher than the potential V1 of the second electrode,
the first electrode being arranged in the internal space, spaced apart from the first dielectric wall by the gas (by one or more spacers, by a peripheral frame, etc.), and closer to the first dielectric wall than the second electrode,
the first and second electrodes being separated by a flat electrical insulator, especially parallel to the walls, with at least one main face, known as a perforated face, equipped with through-holes,
at least one of the first and second electrodes being in contact with the main perforated face and having discontinuities at least in the extension of the holes.

The flat discharge lamp according to the invention brings together many assets:
high luminous efficiency due to microdischarges localized in the holes of the electrical insulator, which promotes the excitation of the plasma gas and therefore the production of UV (UV exciting from a light source or other UV source(s), or forming the direct source of a UV lamp);
absence of direct bombardment, by the plasma, of the phosphors (that emit in the visible and/or UV) optionally present, especially on the inner face opposite the through-holes;
vast possible choice for the electrodes (opaque or transparent, as a layer, as a wire, as a plate, etc.) whether the radiation is emitted via one and/or both walls; and
more readily ensured electrical safety since the first electrode is internal and is spaced apart from the first wall by an insulating gas (the plasma gas) for example having a height of 0.5 mm to a few mm.

The first electrode is protected by the two walls. The lamp is compact, easy to transport and handle and is used directly in numerous UV or lighting applications, especially without having to use an additional discharge chamber.

The lamp must be hermetically sealed; the peripheral sealing may be achieved in various ways:
by (at least) one sealing joint (silicone-type polymer, or mineral, glass frit-type); and
by (at least) one peripheral frame linked to the walls (by bonding or any other means for example by a film made of glass frit), for example made of glass.

A frame may be used as a spacer, may replace one or some “point” spacers.

The insulator may be a single perforated dielectric, or may be a stack of dielectrics (composite laminated insulator, for example).

The electrode with the discontinuities may be on the main perforated face, positioned or fixed by any means (adhesive, etc.) onto this main face or partially integrated into this face. More simply, it may be deposited onto the main face, especially in the form of a discontinuous layer.

For better mechanical strength, thermal resistance and resistance to the plasma, and to avoid any pollution, the electrical insulator may preferably (essentially) be made from a mineral (ceramic, glass-ceramic, glass, etc.) material. More preferably still, it may comprise (or even consist of) a glass sheet, for example made of soda-lime-silica glass in particular, the first and second electrodes being on the main opposite faces of the electrical insulator.

More specifically, in a first design of the invention, the electrical insulator comprises, preferably consists of, the mineral sheet spaced apart from the first and second dielectric walls, the first and second electrodes being on the main faces of the sheet.

Preferably, the mineral sheet may be at an equal distance from the first and second dielectric walls.

The first holes may be blind, then only opening into the discontinuities of the first electrode (respectively of the second electrode). The second electrode (respectively the first electrode) may then be either continuous or discontinuous.

Optional second holes, opposite or offset from the first holes, may be blind and opening into the discontinuities of the first electrode (respectively of the second electrode).

With blind holes, the electrode associated with the face opposite to the perforated face is protected from bombardment by the plasma.

In the case of blind holes, the dielectric barrier between the electrodes has a thickness corresponding to the remaining, preferably small, thickness of insulator.

The holes may be through-holes. The lamp then no longer has a dielectric barrier and V0 may be further reduced. In this hypothesis, the first and second electrodes may each preferably have discontinuities at least in the extension of the through-holes. They only undergo a tangential bombardment (that is therefore of limited intensity) via the sides.

Advantageously, the mineral sheet may be thin, for example in order to increase the height of the space between the sheet and each wall for greater electrical safety or in order to reduce the total height of the lamp for greater compactness.

The thickness of this mineral sheet—or even the total thickness of the chosen composite electrical insulator—may be, for example, less than or equal to 5 mm, especially between 0.5 and 2 mm.

The mineral sheet may advantageously be kept at constant distances from each of the dielectric walls by a spacer (for example a peripheral frame) or preferably by dielectric spacers, in the internal space. The spacers are arranged on either side of the sheet, at the periphery or preferably distributed (regularly, uniformly) in the internal space.

These spacers are not conductors in order not to participate in discharges or cause a short circuit. Preferably, they are predominantly glass, for example made of soda-lime-silica glass.

The spacers may have a shape that is spherical, cylindrical, cubic or of another polygonal, for example cruciform, cross section. These spacers may be distributed regularly and over the entire surface of the electrical insulator.

The spacers may also be elongate and, for example, of rectangular cross section; and positioned at the periphery. On each side of the sheet the spacers may form, for example, a peripheral frame preferably combined with a central spacer or with crossed and centred spacers.

The spacers may be coated with a phosphor that is identical to or different from the phosphor that emits light and/or UV.

The spacer or spacers may be bonded via a preferably mineral film such as a glass frit, of a few hundreds of μm or even smaller thickness.

Advantageously, in connection with this first design, the insulator may be sealed with the first and second dielectric walls at the periphery, for example two peripheral seals on either side of the insulator, preferably made of an (essentially) mineral (glass frit, etc.) material.

As a variant, two peripheral frames (made of glass, etc.) are chosen that are, for example, heat-sealed or else bonded via a preferably mineral film such as a glass frit, having a thickness of a few hundreds of μm or even less.

Such frames may also be used as spacers, replacing one of the point spacers.

And, preferably, the insulator is a mineral sheet having dimensions substantially identical to the dimensions of the first and second dielectric walls.

With this double sealing, provision may be made for the power supply of each electrode, especially layer electrode, to be achieved by simply electrically connecting each electrode with a peripheral electrically conductive zone of the power supply, on the main inner face of the insulator involved. This peripheral electrically conductive zone may be (completely or partially) outside the internal space, or even jutting over the edge of the insulator. This zone, for example that forms a strip known as a “busbar”, (made of silver enamel, etc.) is itself connected, for example by soldering, to a power supply means.

The seal or seals (the seals for the peripheral frames) may be set back relative to the edges of the walls, for example by 0.5 to a few mm.

The first electrode and/or the second electrode, especially a layer, may be jutting out over an edge of the lamp, outside of the internal space (therefore beyond the seal) and may be connected to a power supply means directly, in particular when the electrode material is based on silver, or via this peripheral electrically conductive zone described.

In a second design of the invention, the second electrode, the electrical insulator and the first electrode are positioned or attached (bonded, for example, via a glass frit, as deposited layers, etc.) on the inner face of the second dielectric wall.

The second electrode, the electrical insulator and the first electrode may form a stack of layers.

With a stack of three layers, the holes and discontinuities may preferably be produced by a laser.

The electrical insulator may be, for example, a layer of silica, alumina, mica, etc.

The peripheral seal (peripheral sealing joint or peripheral frame) may be set back relatively to the edges of the walls, for example by 0.5 to a few mm.

The second electrode, especially a layer electrode deposited on the inner face of the second wall, may jut out towards one edge of the lamp, outside of the internal space (therefore beyond the seal) to facilitate the power supply.

The second electrode may be connected, over one edge of the lamp, directly to a power supply cable in particular when the electrode material is based on silver. The second electrode may also be in electrical connection with a peripheral electrically conductive zone of the power supply on the inner face of the second wall and outside of the internal space (completely or partially). This peripheral electrically conductive zone, for example that forms a strip known as a “busbar”, (made of silver enamel, etc.) is itself connected, for example by soldering, to a power supply cable.

The electrical insulator may also be a mineral sheet with the first electrode, as a deposited layer, or even the second electrode on its main faces.

The second electrode may also be partially integrated into the inner face of the insulator, especially in the form of conductive wires.

In this second design, the first electrode may be kept at a constant distance from the first dielectric wall by one or more spacers that are at least predominantly dielectric, especially glass, such as those described already for the first design or by the peripheral frame for the sealing.

The electrical insulator may have blind holes or through-holes such as those described for the first design.

For the supply of current to the first electrode, other alternatives are possible in these latter two designs, in particular when a single peripheral seal or a single peripheral frame are provided, that directly seal the dielectric walls together.

Thus, the lamp may comprise:
at least one electrically conductive spacer positioned at the edge and over the first electrode (mechanical contact, via pressure, or contact via a conductive adhesive, soldering, etc.), for example spacers that are electrically conductive in their bulk or glass spacers coated with an electrically conductive material; and/or
at least one electrically conductive element, for example metallic elements, at the edge and over the first electrode especially chosen from one or more of the following means: metal, optionally elastic, tab, (spring, etc.), wire, contact stud made of enamel-type conductive paste, a solder, especially made of a tin-silver alloy.

The spacer or spacers, just like the electrically conductive element or elements, may be in electrical contact with a peripheral electrically conductive zone of the power supply on the inner face of the first dielectric wall, for example a strip known as a “busbar” especially made of silver enamel, preferably screen printed. This peripheral electrically conductive zone preferably exits from the internal space and is connected to a power supply means (cable, wire, foil, etc.).

For the first design, provision may be made for identical means (spacer and/or electrically conductive element) for the power supply of the second electrode.

If the seal is made from a sufficiently conductive material, preferably an electrical insulator is added between the seal and the first or second wall.

The first electrode may be powered by a periodic signal typically at high frequency of around 1 to 100 kHz, preferably greater than or equal to 40 kHz.

The signal may be alternating, sinusoidal, pulsed, or a square-wave signal.

The first electrode may also be DC powered when the holes are through-holes. More specifically, in the first design of the invention with the discontinuous internal electrodes spaced apart from the walls by the gas and with through-holes, V0 is equal to the direct discharge voltage and V1 is equal to earth potential. Electromagnetic screening is not necessary and there is no leakage current generated on approaching the metallic body of one of the dielectric walls.

In the first design of the invention with the internal electrodes that are spaced apart from the walls by the gas, it is possible, as a second power supply option, to choose an AC power supply, with V0 equal to half of the discharge voltage, for example V0 between 250 and 500 V (typically peak voltage) and V1 equal to half the negative discharge voltage Vd, for example V1 between −250 and −500 V. It is also possible to make an asymmetric distribution, the sum (in absolute value) being equal to V0.

It is not necessary to add electrical conductors to the earth or to the power grid on the two outer faces for electrical safety in order to limit the leakage current generated on approaching the metallic body of one of the dielectric walls. This is because the plasma remains trapped in the holes. The voltage between this metallic body and the electrode involved is well below the discharge voltage for generating a plasma in this space. Thus, even when approaching this metallic body, there is no risk for the user since the gas in the space between the electrode involved and the opposite wall is and remains electrically insulating.

However, it is possible to provide such conductors to the earth in order to meet electromagnetic compatibility standards. These may be transparent conductors where necessary.

It is also possible, as a third power supply option, to choose an AC power supply with V0 greater than or equal to the discharge voltage Vd and less than the discharge voltage necessary to create a discharge between the first electrode, the gas, the glass and an electrical conductor which might be connected. V1 is then chosen to be equal to earth potential or to an AC voltage less than or equal to 400 V (typically peak voltage), especially less than or equal to 220 V, at a frequency f that is less than or equal to 100 Hz, preferably less than or equal to 60 Hz, for example equal to the power grid (220 V, 50 Hz).

Again, it is not necessary to add an electrical conductor to the earth or to the power grid on the outer face of the first wall for electrical safety.

In the second design of the invention, it is preferred to choose the third power supply option, since the second electrode is on the inner face of the second wall.

In a third preferred design of the invention, the electrical insulator comprises, preferably consists of, the second dielectric wall with blind holes on its inner face, the first electrode on the inner face of the second wall being discontinuous and the second electrode being integrated into the second wall or outside of the internal space.

The first and second dielectric walls may be kept at a constant distance by a peripheral frame, and/or by one or more dielectric and/or conductive spacers, especially such as those already described.

The peripheral sealing (seal or frame) may be set back relative to the edges of the walls, for example by 0.5 to a few mm.

The first electrode, especially a layer, may jut out over an edge of the lamp, outside of the internal space (beyond the sealing).

The first electrode may be connected to a power supply cable directly, in particular when the electrode material is based on silver. The first electrode may also be in electrical connection with a peripheral electrically conductive zone of the power supply on the inner face of the second wall and outside of the internal space (completely or partially). This peripheral electrically conductive zone, for example forming a strip known as a “busbar”, (made of silver enamel, etc.) is itself connected, for example by soldering, to a power supply cable.

The electrical insulator may be composite, for example formed from the second dielectric wall and plastic film(s) on its outer face bearing the second electrode, especially one (some) interlayer film(s) for laminating with a glass backing or a suitable plastic.

It is also possible to choose the third power supply option described previously.

The light source may comprise the plasma gas and/or an additional gas and/or at least one phosphor layer excited by the gas(es) in the internal space and deposited over at least one of the inner faces of the walls.

As gases emitting in the visible, especially for screened light, mention may be made of rare gases: helium, neon, argon, krypton, xenon, or other gases (air, oxygen, nitrogen, hydrogen, chlorine, methane, ethylene, ammonia, etc. and mixtures thereof).

As gases emitting in the UV, a gas or a gas mixture is used, for example a gas that effectively emits said UV radiation, especially xenon, or mercury or halides and a gas that can easily be ionized and is capable of constituting a plasma (i.e. a plasma gas) such as a rare gas, for example neon, xenon or argon, or else helium, or halides, or else air or nitrogen. Examples are described in Application FR 2889886, incorporated here by reference.

The phosphor may be opaque or transparent especially as described in Application FR 2867897, incorporated here by reference.

The phosphor layer may be continuous or discontinuous, especially in the visible, for example to form zones of lighting and dark zones.

It is possible to choose the phosphor coating(s) as a function of the UV or UVs that it is desired to produce.

In particular, phosphors exist that emit in the UVC starting from a VUV radiation, for example produced by one or more rare gases (Ar, Kr, etc.). For example, a UV radiation at 250 nm is emitted by phosphors after excitation by a VUV radiation below 200 nm. Mention may also be made of materials doped with Pr or Pb such as: LaPO₄:Pr; CaSO₄:Pb; etc.

Phosphors also exist that emit in the UVA or near UVB also starting from a VUV radiation. Mention may be made of gadolinium-doped materials such as YBO₃:Gd; YB₂O₅:Gd; LaP₃O₉:Gd; NaGdSiO₄; YAl₃(BO₃)₄: Gd; YPO₄:Gd; YAlO₃:Gd; SrB₄O₇:Gd; LaPO₄:Gd; LaMgB₅O₁₀:Gd, Pr; LaB₃O₈:Gd, Pr; (CaZn)₃(PO₄)₂:Tl.

Furthermore, phosphors exist that emit in the UVA starting from a UVB or UVC radiation, for example produced by mercury or preferably one (some) gas(es) such as the rare gases and/or halogens (Hg, Xe/Br, Xe/I, Xe/F, Cl₂, etc.). Mention may be made, for example, of LaPO₄:Ce; (Mg,Ba)Al₁₁O₁₉:Ce; BaSi₂O₅:Pb; le YPO₄:Ce; (Ba,Sr,Mg)₃Si₂O₇:Pb; SrB₄O₇:Eu. For example, a UV radiation above 300 nm, especially between 318 nm and 380 nm, is emitted by phosphors after excitation by UVC radiation of around 250 nm.

The first electrode and/or the second electrode may be protected from the bombardment by a dielectric, especially as a layer, such as an oxide, a nitrate, in particular a silica, a silicon nitride, a barium sulphate BaSO₄, a manganese oxide or an alumina.

The first electrode, like the second electrode (or any other conductor added) may be a layer (single layer or multilayer) made of any electrically conductive material, especially:
a metal: silver, copper, molybdenum, tungsten, aluminium, titanium, nickel, chromium, platinum or gold;
a transparent multilayer comprising a thin pure, alloyed or doped (silver, etc.) functional metallic layer between two dielectric layers made of a single or mixed and/or doped metal oxide (zinc oxide, ITO, IZO, etc.), or made of metal nitrides (metal in the broad sense, silicon being included, for example Si₃N₄);
a conductive metal oxide that is especially transparent and/or that has electron holes, such as tin oxide doped with fluorine or with antimony, zinc oxide doped or alloyed with at least one of the following elements: aluminium, gallium, indium, boron, tin (for example ZnO:Al, ZnO:Ga, ZnO:In, ZnO:B, ZnSnO);
indium oxide doped or alloyed in particular with zinc (IZO), gallium and zinc (IGZO), or tin (ITO);
a conductive enamel, preferably a silver enamel (especially a silver fused glass frit); and
a conductive ink, especially an ink filled with metallic (nano)particles, for example a screen-printable silver ink such as the ink TEC PA 030™ from InkTec Nano Silver Paste Inks.

This layer may be deposited by any known deposition means, such as liquid deposition, vacuum deposition (magnetron sputtering, evaporation), by pyrolysis (powder or gas route) or by screen printing, by an inkjet, by applying with a doctor blade or more generally by printing.

This layer may have a thickness of less than 50 μm, more preferably still less than 20 μm, or even 1 μm. It may especially be a thin film, for example having a thickness of less than 50 nm, deposited under vacuum.

One electrode material (first electrode and/or second electrode) is, for example, based on metallic particles or conductive oxides, for example those already cited.

(Nano)particles may be chosen, that are therefore of nanoscale size (for example with a maximum nanoscale dimension and/or a nanoscale D50), especially having a size between 10 and 500 nm, or even less than 100 nm to facilitate the deposition, the formation of fine features (for a sufficient overall transmission for example), in particular by screen printing.

As metallic (nano)particles (sphere, flake, etc.) it is possible to choose, in particular, (nano)particles based on Ag, Au, Al, Pd, Pt, Cr, Cu, Ni.

The (nano)particles are preferably in a binder. The resistivity is adjusted via the concentration of (nano)particles in a binder.

The binder may optionally be organic, for example polyurethane, epoxy or acrylic resins, or be produced by the sol-gel process (mineral, or hybrid organic-inorganic, etc.).

The (nano)particles may be deposited from a dispersion in a solvent (alcohol, ketone, water, glycol, etc.).

Commercial products based on particles that may be used to form the first and/or the second electrode are the products sold by Sumitomo Metal Mining Co. Ltd. below:
X100®, X100®D particles of ITO dispersed in a resin binder (optional) and with a ketone solvent;
X500® particles of ITO dispersed in an alcohol solvent;
CKR® particles of gold-coated silver in an alcohol solvent;
CKRF® agglomerated particles of gold and of silver.

The desired resistivity is adjusted as a function of the formulation.

Nanoparticles are also available from Cabot Corporation USA (e.g. Product No. AG-IJ-G-100-S1) or from Harima Chemicals, Inc. in Japan (NP series).

Preferably, the (nano)particles and/or the binder are essentially inorganic.

For the first electrode and/or for the second electrode it is possible to choose:
a screen-printing paste, especially:
a paste filled with (nano)particles (such as already cited, preferably silver and/or gold): a conductive enamel (the silver fused glass frit for example), an ink, a conductive organic paste (having a polymer matrix), a PSS/PEDOT (for example from Bayer, Agfa) and a polyaniline,
a sol-gel layer with (metallic) conductive (nano)particles that precipitate after printing; and
a conductive ink filled with (nano)particles (such as already cited, preferably silver and/or gold) deposited by inkjet, for example the ink described in document US 2007/0283848.

Preferably, the first electrode and/or the second electrode is essentially inorganic.

One arrangement for overall (UV and/or visible) transparency of the first electrode and/or of the second electrode (and for eventual security conductors) may be obtained directly by discontinuous deposit(s) of opaque electrically conductive material(s) (such as those already cited) in order to reduce the manufacturing costs. Thus, post-structuring operations are avoided, for example dry and/or wet etching operations, that often require lithographic processes (exposure of a resist to a radiation and development).

This direct arrangement as an array may be obtained directly by one or more suitable deposition methods, preferably a deposition via a liquid route, via printing, especially flat or rotary printing, for example using an ink pad, or else via an inkjet (with a suitable nozzle), via screen or silk printing or by simple application with a doctor blade.

Via screen or silk printing, a synthetic, silk, polyester or metallic cloth with a suitable mesh width and a suitable mesh fineness is chosen.

Typically, for a grid arrangement of conductive tracks, (first and/or second electrode even optional safety conductor(s)), the width of the tracks may be between 5 μm and 200 μm, the pitch between tracks being between 100 μm and 1 mm. A ratio of width to pitch preferably less than or equal to 50%, more preferably still 10%, for a sufficient overall transmission to the UV and/or visible, is preferred.

The first electrode may be based on conductive wires. The conductive wires are especially metallic (for example tungsten, copper, etc.) and/or thin (for example, having a cross section between 10 μm and 2 mm).

The conductive wires are connected to the main face of the insulator by any suitable (temperature resistant, etc.) adhesive means. These wires may be partially integrated into the main face.

Apart from the possible discontinuities that extend the holes of the insulator, the first electrode may be continuous or may be discontinuous.

Thus, the first electrode may be based on conductive tracks or wires. It may be in the form of a series of strips or lines, in particular that are equidistant and/or parallel, or even of at least two overlapped series of strips or lines.

Thus, the first electrode may be organized as a grid, fabric or cloth, especially obtained by screen printing, by an inkjet.

The second electrode may be, in the internal space:
spaced apart from the second wall, on the inner face or partially integrated into the inner face of the electrical insulator;
on the inner face (placed or attached) of the second wall that forms the electrical insulator; and
incorporated into the second wall (for example a grid, framework, forming the electrical insulator).

Where necessary, it may be protected like the first electrode.

The second electrode may finally be outside of the internal space, preferably in contact with the outer face:
placed on or even attached to the outer face (deposited, bonded, etc.); and
borne by or integrated into an outer dielectric (interlayer film or rigid plastic), for example a rigid polyurethane, polycarbonates, acrylates such as polymethyl methacrylate (PMMA). It is also possible to use PE, PEN or PVC or else polyethylene terephthalate (PET), the latter possibly being thin, especially between 10 and 100 μm.

As already described, apart from the possible discontinuities that extend the holes of the insulator, the second electrode may be continuous or may be discontinuous.

Thus, the second electrode may be based on conductive tracks or conductive wires. It may be in the form of a series of strips or lines, in particular that are equidistant and/or parallel, or even of at least two overlapped series of strips or lines.

Thus, the second electrode may be organized as a grid, fabric or cloth, especially obtained by screen printing, by an inkjet.

The second electrode, especially incorporated into the second wall or outside of the second wall, may be made of an electrically conductive material that reflects visible and/or UV light or that transmits visible and/or UV light or that is capable of an overall transmission of visible and/or UV light (when the material absorbs or reflects UV light) for its arrangement, as always indicated.

The through-holes may be of any, especially geometrical, shape: rectangular, round, square, being elongate or not.

It is thus possible to form grooves or rows of “point” holes that are parallel, in staggered rows, etc. The grooves or rows, for example parallel to the edge of the insulator, may be spaced apart by 0.1 mm to 3 cm. And within one row, the holes may be spaced apart by 0.1 mm to 3 cm.

The holes preferably have a straight or conical cross section, a width of 0.1 to 5 mm and a depth of at least 0.1 mm.

Naturally, to maximize the number of microdischarges, it is possible to make a large number of holes and the first and second electrodes may extend over surfaces having dimensions that are at least essentially equal to the surface of the walls inscribed in the internal space.

The visible and/or UV radiation may preferably be two-directional (emission of the radiation by the main faces of the two walls).

Naturally, the first electrode and/or the second electrode may be discontinuous, for example in the form of strips that are spaced apart, the electrode zones being powered jointly by the given respective potential, in particular powered jointly through at least one “bus bar”.

Preferably, the transmission coefficient of the lamp according to the invention around the peak of UV and/or visible radiation is greater than or equal to 50%, more preferably still greater than or equal to 70% and even greater than or equal to 80%.

The dielectric walls that transmit the visible may be glass sheets, especially made of soda-lime-silica glass.

The dielectric walls that transmit the UV may preferably be chosen from quartz, silica, magnesium fluoride (MgF₂) or calcium fluoride (CaF₂), a borosilicate glass, or a soda-lime-silica glass, especially with less than 0.05% of Fe₂O₃.

As examples for thicknesses of 3 mm:
the magnesium or calcium fluorides transmit more than 80%, or even 90%, over the entire range of UV bands, that is to say UVA (between 315 and 380 nm), UVB (between 280 and 315 nm), UVC (between 200 and 280 nm) or VUV (between around 10 and 200 nm);
quartz and certain high-purity silicas transmit more than 80%, or even 90%, over the entire range of UVA, UVB and UVC bands;
borosilicate glass, such as Borofloat from Schott, transmits more than 70% over the entire UVA band; and
soda-lime-silica glasses with less than 0.05% of Fe(III) or of Fe₂O₃, especially the Diamant glass from Saint-Gobain, the Optiwhite glass from Pilkington, the B270 glass from Schott, transmit more than 70%, or even 80%, over the entire UVA band.

However, a soda-lime-silica glass, such as the Planilux® glass sold by Saint-Gobain, has a transmission greater than 80% above 360 nm which may be sufficient for certain constructions and certain applications.

Glass that is sufficiently transparent to the UV bands is described in Application FR 2889886, incorporated here by reference.

The dielectric walls may be of any shape: the contour of the walls may be polygonal, concave or convex, especially square or rectangular, or curved, having a constant or variable radius of curvature, especially round or oval.

For mechanical protection, an additional electrical insulator may also be another dielectric wall, especially one made of glass, which is laminated to at least one of the glass walls forming the lamp, via a plastic interlayer film or other material, especially a resin, capable of making the two substrates adhere to one another.

As an interlayer plastic film, mention may be made of an element made from a polymer material, for example made of polyethylene terephthalate (PET), made of polyvinyl butyral (PVB), made of ethylene/vinylacetate (EVA), made of polyurethane (PU) for example, with a thickness between 0.2 mm and 1.1 mm, especially between 0.3 nm and 0.7 mm.

In the structure of the flat lamp according to the invention, the gas pressure in the internal space may be around 0.05 to 1 bar, advantageously around 0.05 to 0.6 bar. The gas used is an ionizable gas capable of forming a plasma (“plasma gas”), especially xenon or neon, pure or as a mixture.

The invention applies to any lamp for any type of light source (plasma gas, phosphor, etc.), and of any size.

The uses of a flat lamp may be diverse: lamps with single-directional and/or two-directional illumination, lamps for decoration, or backlighting of displays.

The invention targets, for example, the production of architectural or decorative elements that are illuminating and/or that have a display function (indicating elements, of the type of emergency exit panels, and/or with a luminous logo or trademark), such as luminaires, luminous, especially suspended, walls, luminous tiles, etc.

The luminous panel according to the invention may also be intended for buildings, in a transport vehicle, in road lighting, in urban or domestic furniture, or in electronics.

The luminous panel may, in particular, be a ceiling light, a bus shelter panel, a wall of a display counter, a jewelry display or shop window, a shelf or cabinet element, a facade of a cabinet, an illuminating refrigerator shelf, an aquarium wall, a greenhouse wall. It may also be an illuminating mirror. The luminous panel may be used for illuminating a bathroom wall or a kitchen worktop.

It is also conceivable for the lamp according to the invention to be fitted into glazed, especially sliding, doors, internal partitions between rooms in a building, especially in offices, or between two areas/compartments of means of terrestrial, airborne or waterborne locomotion, or for fitting into windows or any type of container.

Single-directional lighting is useful, for example, for backlighting of displays, especially liquid crystal displays (LCDs).

Naturally, for a two-directional lighting, all the elements oriented more on the outside than the light source of the structure are, over one common part, substantially transparent or overall transparent (for example, in the form of an arrangement with a relatively opaque absorbing and/or reflecting material, in order to allow the light emitted to sufficiently pass), as a grid for example, or translucent.

In one embodiment, the electrodes, the optional phosphor layer(s), the optional safety conductor or safety conductors and also the electrical insulator are made of materials that transmit visible light or are capable of an overall transmission of visible light thanks to their arrangement.

The lamp in the visible range may be part of a window (transom, etc.), be integrated into a double glazing unit, and constitute an illuminating window (on the whole area or not). The lamp in the visible range may thus be fitted into any window of a building or of means of locomotion (train windows, ship or aircraft cabin windows, roof or side windows of industrial vehicles, or even portions of rear windows or windscreens).

It may moreover be advantageous to incorporate into the (UV) lamp, a coating having a given functionality. It may be a coating having the role of blocking radiation with a wavelength within the infrared for example for an electromagnetic compatibility with a low-emitting role, (for example made of a doped metal oxide such as SnO₂:F or indium oxide doped with tin, ITO) or with a solar control for building or automotive applications. For that, one or more layers of silver surrounded by dielectric layers, or layers made of nitrides such as TiN or ZrN or made of metal oxides or made of steel or made of an Ni—Cr alloy) may be used.

An antisoiling coating (photocatalytic coating on outer faces comprising TiO₂ at least partially crystallized in anatase form), or else an antireflection multilayer of the type, for example, Si₃N₄/SiO₂/Si₃N₄/SiO₂ on outer faces, may be preferred.

The UV lamp such as described previously may be used both in the industrial field, for example in the beauty, electronics or food fields, and in the domestic field, for example for decontaminating tap water, drinking water, swimming pools, or air, UV drying or polymerization.

By choosing radiation in the UVA range or even in the UVB range, the UV lamp such as described previously may be used:
as a tanning lamp (in particular 99.3% in the UVA range and 0.7% in the UVB range according to current standards), in particular built into a tanning booth;
for photochemical activation processes, for example for curing, especially of adhesives, or crosslinking or for drying paper;
for the activation of fluorescent material, such as ethidium bromide used as a gel, for analyses of nucleic acids or of proteins; and
for the activation of a photocatalytic material, for example to reduce the odours in a refrigerator or the dirt.

By choosing radiation in the UVB range, the lamp is used to promote the formation of vitamin D in the skin.

By choosing radiation in the UVC range, the UV lamp such as described previously may be used for disinfecting/sterilizing air, water or surfaces via a germicidal effect, especially between 250 nm and 260 nm.

By choosing radiation in the far UVC or preferably in the VUV for the production of ozone, the UV lamp such as described previously is especially used for treating surfaces, in particular before deposition of active layers in the field of electronics, computer science, optics, semiconductors, etc.

Other details and features of the invention will appear from the detailed description which follows, given with reference to the appended drawings in which:

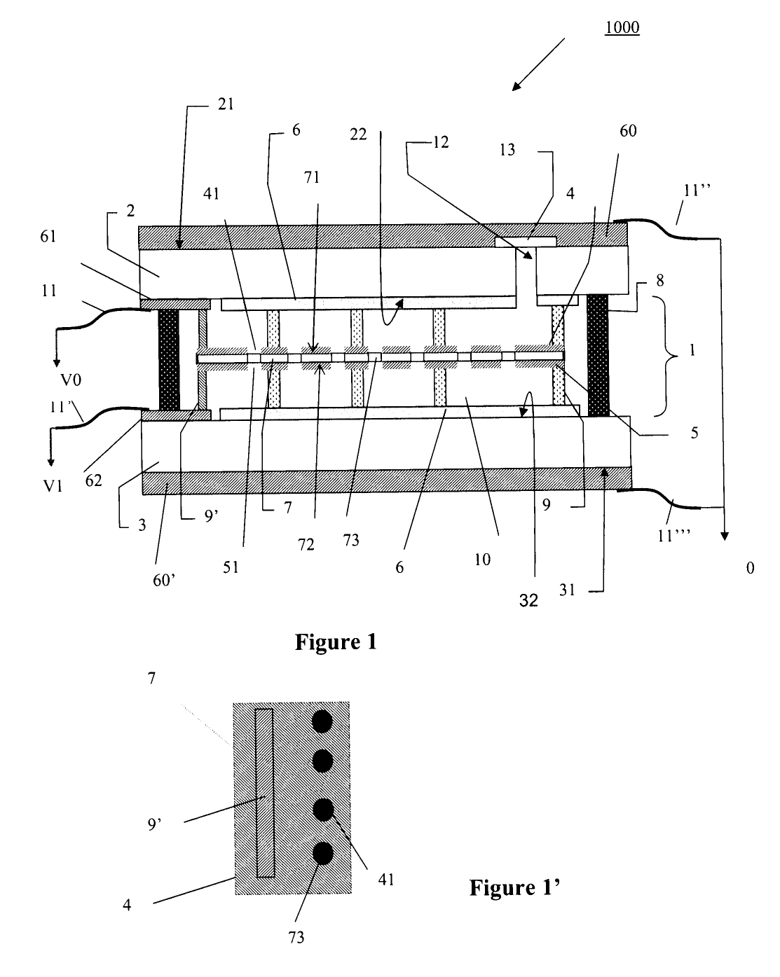

FIGS. 1 and 1′ respectively represent a schematic cross-sectional view of a flat lamp according to the invention and a partial top view of the electrical insulator bearing electrodes;

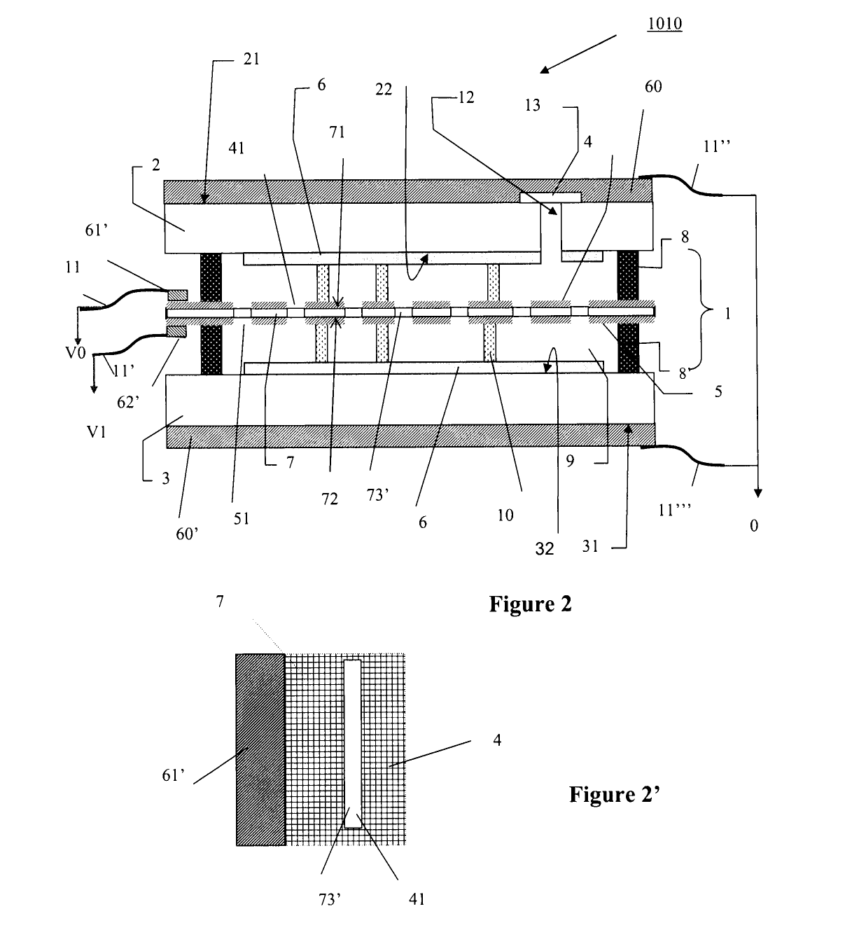

FIGS. 2 and 2′ respectively represent a schematic cross-sectional view of a flat lamp in another embodiment according to the invention and a partial top view of the electrical insulator bearing electrodes; and

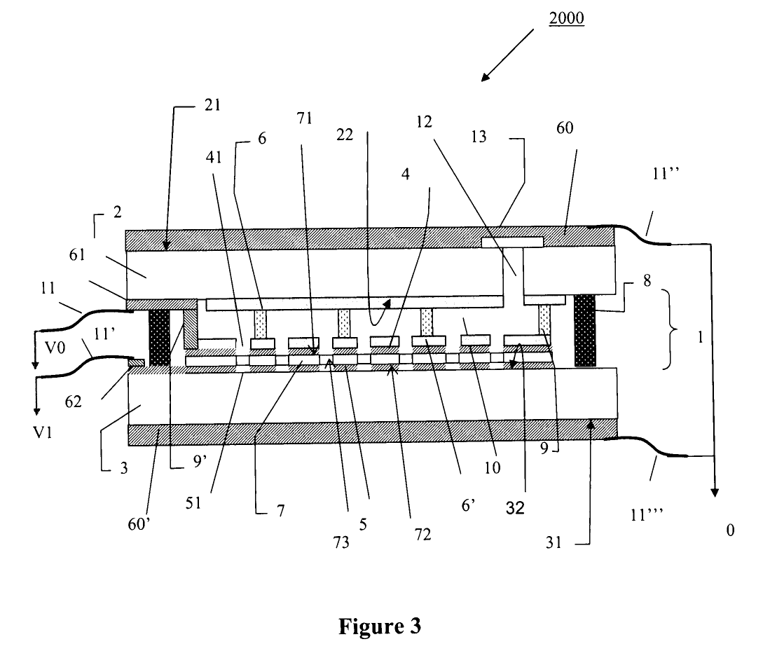

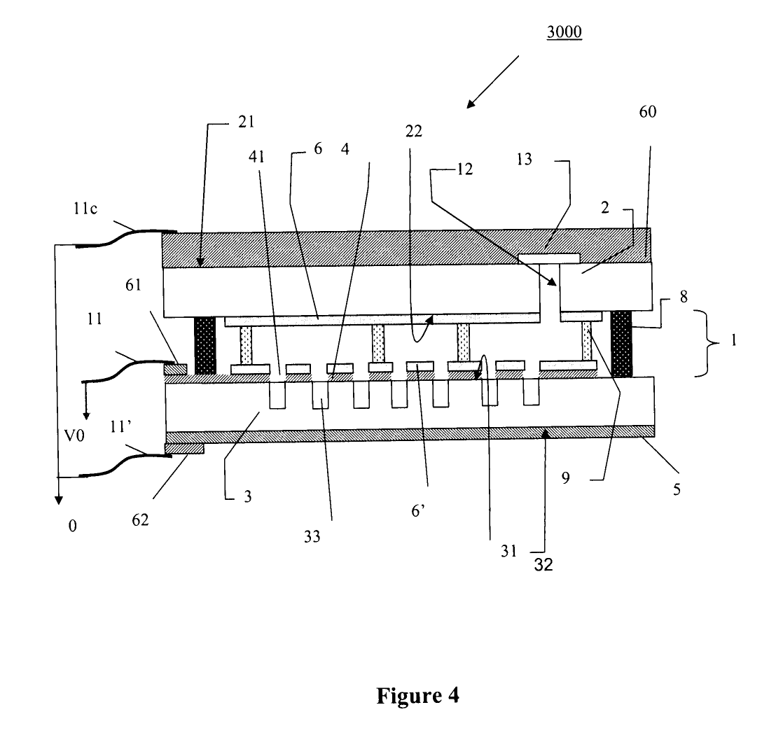

FIGS. 3 and 4 represent schematic cross-sectional views of other embodiments of flat lamps according to the invention.

It is stated that, for reasons of clarity, the various elements of the objects represented are not necessarily reproduced to scale.

FIG. 1 is a schematic cross-sectional view of a flat lamp 1000 constituted of a part 1 formed from first and second walls made from glass sheets 2, 3 for example of around 3 mm in thickness, rectangular and made of soda-lime-silica glass.

The first and second glass sheets 2, 3 each have:
outer faces 21, 31; and
inner faces 22, 32 which each bear a coating of a photoluminescent material 6 that, for example, is transparent and is, for example, in the form of phosphor particles dispersed in an inorganic matrix, for example one based on lithium silicate.

The glass sheets 2, 3 are associated with their inner faces 22, 32 being opposite each other and are assembled via a sealing frit 8, for example at around 1 mm from the edges. The seal is set back from the sheets, for example by 1 mm.

In an internal space 10 between the glass sheets 2, 3 there is a reduced pressure, generally of around one tenth of atmospheric pressure, of a rare gas such as xenon, optionally as a mixture with neon or helium.

For its manufacture, deposited on the inner peripheral strip of the two walls is the sealing frit and it is sealed at high temperature.

Next, the atmosphere contained in the sealed chamber is removed by means of a pump through the hole 12 and it is replaced by the xenon/neon mixture. When the desired gas pressure is reached, the sealing plug 13 is introduced in front of the opening of the hole 12, around which a fillet of solder alloy has been deposited. A heat source is activated in the vicinity of the solder so as to cause the softening of the latter, the plug 13 is flattened by gravity against the orifice of the hole and is thus soldered to the wall 2 forming a hermetic closure.

The internal space 10 contains a mineral sheet 7, for example made of soda-lime-silica glass, having a thickness, for example, of around 1 mm, with first and second main faces 71, 72 respectively comprising first and second electrodes 4, 5.

The mineral sheet 7 has dimensions less than the distance between the two opposite sealing edges, therefore less than the first and second walls 2, 3.

The mineral sheet 7 is spaced apart from the first and second walls and kept there by first glass spacers 9 positioned on either side of the sheet and by second metallic spacers 9′ (or, as a variant, made of metallized glass), which are located on the edges of the first and second electrodes 4, 5 (as shown in FIG. 1′). The distances between the sheet 7 and the walls 2, 3 are constant, for example of around 2 mm each.

At the centre, the first spacers 9 are, for example, beads. At the periphery, the first spacers 9 (the furthest right in FIG. 1) may be elongate and rectangular just like the second spacers 9′ (one of which is shown in FIG. 1′).

As a variant, the second spacers 9′ are replaced by fillets or spots of solder, for example that is based on tin and silver.

The mineral sheet 7 has through-holes 73, for example a multitude of parallel rows of round holes, each row extending over almost the entire length of the mineral sheet 7 (as shown in FIG. 1′). The width of each hole is, for example, around 1 mm. In one row, the holes 73 are spaced 3 mm apart. And the rows of holes are, for example, spaced 3 mm apart.

As a variant, the rows of round holes are replaced by grooves, for example longitudinal grooves.

Each electrode 4, 5 has discontinuities 41, 51 at least in the extension of the through-holes 73. They may be wider.

The electrodes 4, 5 are preferably in the form of electrically conductive, for example metallic, especially of screen-printed silver layers, or as a thin layer deposited by sputtering. The discontinuities 41, 51 are preferably produced at the time of perforating the sheet 7 coated with two solid electrically conductive layers.

The electrodes 4, 5 may be chosen to be transparent (transparent material or distributed for an overall transmission in the visible range) in particular when the phosphor is transparent in order to form a transparent lamp.

The electrodes may be coated with a protective electrical insulator (not shown), for example an oxide, a nitride, especially a silica, a silicon nitride, a barium sulphate, a manganese oxide or an alumina. This insulator may additionally cover the holes 73.

The plasma is trapped in the through-holes 73 whilst the UV radiation produced occupies the entire internal space 10 and excites the phosphors 6 with a high yield.

As a variant, the holes are blind holes; they then only open into the face 71 or 72.

The electrodes 4, 5 are connected to an AC electrical power source (not shown) by cables 11, 11′ outside of the internal space.

The first electrode 4 is at a potential V0 equal to half the discharge voltage, for example of around 800 V or even 600 V, and a high frequency fo, for example of 40 to 50 kHz.

The second electrode 5 is at a potential V1 equal to half the discharge voltage as a negative value, for example around −800 or even −600 V, and a high frequency fo of 40 to 50 kHz.

To satisfy the electromagnetic compatibility standards, the outer faces 21, 31 may comprise conductors 60, 60′, earthed by cables 11″, 11′″, made of the material for an (overall) transmission in the visible range, for example thin films deposited directly or deposited onto a PET-type film.

For example, it may be films deposited by sputtering in transparent conductive oxide. It may also be an array of conductive tracks (in grid . . . ) for example made of photolithographed copper or made of screen-printed silver (as enamel, in particular based on a silver fused glass frit, or ink) or ink with conductive particles deposited by ink-jet, or else wires.

As a variant, wired glass is chosen as the walls, the metallic frameworks being used as screening.

As a first variant, the power supply is a DC power supply; it is possible to keep the given values for V0 or V1. In this variant, the electromagnetic screening is pointless.

As a second variant, V0 is greater than or equal to the discharge voltage, for example between 600 and 800 V, and preferably less than the discharge voltage needed to create a discharge between the first electrode 4, the gas, the wall 3 and an electrical conductor positioned on the first wall. V1 is then chosen to be equal to earth potential or to an AC voltage of less than or equal to 400 V, especially less than or equal to 220 V, at a frequency f which is less than or equal to 100 Hz, preferably less than or equal to 60 Hz, for example equal to the power grid (220 V at 50 Hz).

In the peripheral zones of the inner faces 22, 32, for example along the longitudinal edges, electrically conductive zones 61, 62 are provided, preferably in the form of strips, having widths of a few mm for example.

These conductive strips 61, 62 extend on either side of the sealing joint 8. These strips 61, 62 are, for example, in the form of metallic, preferably made of a conductive (silver, etc.) enamel and screen-printed layers. These conductive strips 61, 62 are in electrical contact (by pressure, solder, conductive adhesive, etc.) with the conductive spacers 9′.

The conductive strips 61, 62 may, as a variant, jut out over the edge of the walls and the cables 11, 11′ may then be attached at this location and not in the sealing groove.

It is possible, furthermore, to replace the conductive spacers 9′ and the conductive strips 61, 62 with metallic parts, each being bent into the inner part of the lamp and coming outside of the lamp to clamp the wall in order to hold it.

The lamp 1000 illuminates via its two faces 21, 31. For an orientated illumination a mirror may be provided, for example the screening conductor 60 chosen to be reflective (made of aluminium, etc.).

For an alternative lamp, the phosphors may be eliminated and a gas that emits light, for example coloured or filtered light, is chosen.

For an alternative UV lamp, the wall or walls are chosen to be made of a material that allows UV radiation to pass through (quartz, etc.) and similarly for the optional conductors 60, 60′. The phosphors are removed, the UV source then being a gas, or they are replaced in order to emit in a specific UV range.

The electrodes and the conductors are not necessarily made of the same material. The electrodes are not necessarily electrically powered by the same means nor via the same edge.

In the embodiment from FIG. 2, the structure of the lamp 1010 basically reproduces the lamp 1000 from FIG. 1 apart from the elements described below.

The mineral sheet 7 has dimensions greater than the distance between the opposite sealing edges, preferably dimensions substantially identical to the dimensions of the first and second glass walls 2, 3.

The mineral sheet 7, preferably made of the same material as the walls 2, 3, is sealed with the first and second glass walls 2, 3 by two peripheral seals 8, 8′ on either side of the sheet 7 which are set back relative to the edges of the walls and of the sheet 7.

The space between the sheet 7 and each wall 2, 3 may be reduced, for example by around 0.5 mm.

The electrodes 4, 5 extend beyond the seals 8 at least over one edge (here a longitudinal edge) of the mineral sheet 7. As shown in FIG. 2′, the electrodes 4, 5 are conductive tracks (or conductive wires as a variant) organized as a grid.

The conductive spacers are removed. The peripheral strips for supplying current 61′, 62′ are on the main faces 71, 72 of the sheet 7 and are connected electrically (here via a covering, as shown in FIG. 2′, or by any other means) to the outer edges of the electrodes 4, 5. These peripheral strips are not necessary especially when the tracks are made of silver.

The sheet 7 comprises a multitude of grooves, for example longitudinal grooves (as shown in FIG. 2′). In this configuration, it is preferred that the holes 73′ be through-holes in order to fill the entire internal space with gas by means of a single hole 12.

With blind holes, preferably on the two faces 71, 72, it is also possible to provide a second hole in the wall 3.

The power supply described for FIG. 1 may be retained. The foils 11, 11′ are connected to the peripheral zones 61′, 62′.

All the variants described for the lamp 1000 may be applied to the lamp 1010 (material and asymmetry of the electrodes or of the screening conductors, material of the walls, power supply, addition of a protective insulator, UV lamp, etc.).

In the embodiment from FIG. 3, the structure of the lamp 2000 basically reproduces the lamp 1000 from FIG. 1 apart from the elements described below.

The mineral sheet 7 is placed on the inner face 32 of the second wall. Thus the spacers 9, 9′ are removed from the lower part of the structure 1.

The second electrode 5 projects outside the internal space via one of its longitudinal edges. It is optionally covered by the peripheral zone 61 for the supply of current. A phosphor 6′ covers the first electrode 4 and optionally the walls of the through-holes 73.

As a variant, the mineral sheet 7 is replaced by a mineral layer, for example of silica or of alumina, for example having a thickness of 100 μm.

The distance between the first wall 2 and the first electrode 4 may be, for example, 0.5 mm.

V0 is greater than or equal to the discharge voltage, for example between 600 and 800 V, and preferably less than the discharge voltage necessary to create a discharge between the first electrode 4, the gas, the wall 3 and an electrical conductor placed on the first wall. V1 is then chosen to be equal to earth potential or to an AC voltage of less than or equal to 400 V, especially less than or equal to 220 V, at a frequency f that is less than or equal to 100 Hz, preferably less than or equal to 60 Hz, for example equal to the power grid (220 V at 50 Hz).

The conductors 60 and 60′ are optional.

All the variants described for the lamp 1000 may be applied to the lamp 2000 (material and asymmetry of the electrodes or of the screening conductors, material of the walls, addition of a protective insulator, UV lamp, etc.).

In the embodiment from FIG. 4, the structure of the lamp 3000 basically reproduces the lamp from FIG. 3 apart from the elements described below.

The mineral sheet 7 is removed. The inner face 32 of the second wall 3 has opening holes 33 that are not through-holes, that are for example identical to the holes 73′, and bears the first electrode 4 with discontinuities 41 in the extension of the holes 33. The conductor 60 is optional.

The outer face 31 of the second wall 3 bears the second electrode 5, for example chosen to be continuous and in the form of a preferably transparent layer.

For the power supply, use is optionally made of peripheral conductive strips 61, 62 positioned on the electrodes that jut out over at least one longitudinal edge of the walls 2, 3 outside of the sealing 8.

As a variant, the second electrode 5 is in the second wall 3 (wired glass type), or else is in contact with the outer face 32 and on a related element joined to the second wall 3, for example by bonding.

The examples which have just been described in no way limit the invention.

All the dissymmetries and variants of assembly are possible for the electrodes.

In the case of activation by a plasma gas, differentiated distribution of the photoluminescent material in certain zones makes it possible to convert the energy of the plasma into visible radiation only in the zones in question, in order to form luminous zones (which are themselves opaque or transparent depending on the nature of the photoluminescent material) and permanently transparent juxtaposed zones.

The luminous zone may also form an array of geometrical features (lines, studs, dots, squares or features of any other shape) and the spacings between features and/or the sizes of the features may be varied.

Furthermore, the light source may be a plasma gas.

The walls may be of any shape: an outline may be polygonal, concave or convex, especially square or rectangular, or curved, having a constant or variable radius of curvature, especially round or oval.

The walls may be glass substrates, having an optical effect, especially substrates that are coloured, decorated, structured, diffusing, etc.

1. A flat discharge lamp that transmits in the visible and/or UV comprising:
first and second dielectric walls that are facing each other, kept parallel and sealed at the periphery, that thus define an internal space filled with a plasma gas and comprising a source of UV and/or visible light; and
first and second electrodes in separate planes parallel to the first and second walls, the first electrode being at a potential V0 higher than the potential V1 of the second electrode, and the first electrode being arranged in the internal space closer to the first dielectric wall than the second electrode,
wherein the first electrode is spaced apart from the first dielectric wall by the gas, the first and second electrodes are separated by a flat electrical insulator with at least one main face, known as a perforated face, equipped with through-holes, and at least one of the first and second electrodes is in contact with the main perforated face and has discontinuities at least in the extension of said holes.

2. The lamp according to claim 1, wherein the electrical insulator is mainly inorganic and comprises a glass sheet.

3. The lamp according to claim 1, wherein the electrical insulator comprises an inorganic sheet spaced out from the first and second dielectric walls by the gas, the first and second electrodes being on the opposite main faces of the electrical insulator.

4. The lamp according to claim 3, wherein the inorganic sheet is kept at constant distances from the first and second dielectric walls by dielectric spaces positioned on either side of the sheet and in that the spacers are at least predominantly made of glass.

5. The lamp according to claim 3, wherein V0 is equal to half the discharge voltage and V1 is equal to half the negative discharge voltage.

6. The lamp according to claim 3, wherein the holes pass right through and in that the first electrode is supplied with direct current, with V0 equal to the discharge voltage, and V1 to the earth or to the power grid.

7. The lamp according to claim 1, wherein the electrical insulator is sealed with the first and second dielectric walls at the periphery, and preferably the electrical insulator is a sheet with dimensions substantially identical to the dimensions of the first and second dielectric walls.

8. The lamp according to claim 1, wherein the second electrode, the electrical insulator and the first electrode are on the inner face of the second dielectric wall.

9. The lamp according to claim 1, wherein it comprises, positioned on the first electrode and at the edge, at least one electrically conductive spacer, and/or at least one electrically conductive component chosen from one or more of the following means: a metallic tab, a conductive wire, a contact stud made from a conductive paste or a solder especially made of a tin-silver alloy.

10. The lamp according to claim 1, wherein the electrical insulator comprises, the second dielectric wall with blind holes on the inner face, the first electrode being discontinuous and on the inner face of the second wall and the second electrode being integrated into the second wall or outside of the internal space.

11. The lamp according to claim 1, wherein the peripheral seal or seals are set back relative to the edges of the walls, and in that the first electrode and/or the second electrode juts out over one edge of the lamp, outside of the internal space and preferably is in electrical connection outside of the internal space with a peripheral electrically conductive zone of a power supply and/or a power supply means.

12. The lamp according to claim 1, wherein the light source comprises the plasma gas and/or an additional gas and/or at least one phosphor layer excited by the gas(es) and deposited on the inner face of the first wall.

13. The lamp according to claim 1, wherein the first electrode and/or the second electrode is optionally covered with a phosphor and is covered with a protective dielectric chosen from a silica, a silicon nitride, a barium sulphate BaSO₄, a manganese oxide or an alumina.

14. The lamp according to claim 1, wherein the first and/or the second electrode is an electrically conductive layer, having a thickness of less than 50 μm.

15. The lamp according to claim 1, wherein the first electrode and/or the second electrode is based on conductive (nano)particles, and made of conductive enamel, conductive ink or conductive wires.

16. The lamp according to claim 1, wherein the first and/or the second electrode is organized as a grid for an overall UV and/or visible transmission.

17. The lamp according to claim 1, wherein the UV and/or visible radiation is from the two sides of the lamp.

18. The lamp according to claim 1, wherein the dielectric walls are made of glass for the transmission of the visible range or in that the dielectric walls that transmit UV are chosen from quartz, silica, magnesium fluoride (MgF₂) or calcium fluoride (CaF₂), a borosilicate glass, or a soda-lime-silica glass, with less than 0.05% of Fe₂O₃.

19. The lamp according to claim 1, wherein the electrodes, the optional phosphor layer(s), the optional safety conductor or safety conductors, and also the electrical insulator are made of materials that transmit visible light or that are capable of an overall transmission of visible light.

20. The lamp according to claim 1, wherein the lamp emitting in the visible forms a component that is decorative and/or architectural and/or has a signalling and/or display function.

21. The lamp according to claim 1, wherein the lamp emitting in the visible is a facade, an illuminating window, a door such as a rear window, a side window or a sun roof of a motor vehicle or a window or partition for any other terrestrial, waterborne or airborne vehicle, a panel for road or city lighting, an illuminating tile, a ceiling light, a bus shelter panel, a wall of a display counter, a jewelry display or shop window, a shelf or cabinet element, a facade of a cabinet, an illuminating refrigerator shelf, an aquarium wall, a greenhouse wall, an illuminating mirror, or a screen backlighting device.

22. A method of illuminating in buildings, in a terrestrial, waterborne or airborne transport vehicle, in road or city lighting, in urban or domestic furniture, or in electronics wherein the illumination means comprises a lamp that emits in the visible according to claim 1.

23. The lamp according to claim 1, wherein the lamp that emits in the UV is a tanning lamp.

24. A method of illuminating in the beauty, the biomedical, electronics or food fields, for dermatological treatment, for disinfecting or sterilizing surfaces, air, tap water, drinking water or swimming pools, for the treatment of surfaces before deposition of active layers, for activating a photochemical process of the curing or crosslinking type, for drying paper, for analyses starting from fluorescent materials or for activation of a photocatalytic material wherein the illumination means comprises a lamp that emits in the UV according to claim 1.
